(19) United States
(12) Patent Application Publication
(10) Pub. No.: US 2004/0213087 A1
(43) Pub. Date: Oct. 28, 2004

(54) Personal electronic starter and timer and method therefor

(76) Inventors: Warren Gillette, Scottsdale, AZ (US); H. Gordon Minns, Cave Creek, AZ (US)

Correspondence Address: WEISS & MOY PC, 4204 NORTH BROWN AVENUE, SCOTTSDALE, AZ, 85251, US

(21) Appl. No.: 10/822,407

(22) Filed: Apr. 12, 2004

Related U.S. Application Data
(60) Provisional application No. 60/464,210, filed on Apr. 22, 2003.

(51) Int. Cl. G04F 8/00; G04F 10/00; G08B 23/00

(52) U.S. Cl. 368/107

(57) ABSTRACT

A personal electronic starter and timer has a finish line unit for generating an end of race signal across a finish line of a race of a predetermined distance. A body unit is coupled to a body of a person. The body unit is used for generating a countdown signal and starting a timing function after a start signal, the timing function terminating when the body unit reads the end of race signal generated by the finish line unit.

### RELATED APPLICATIONS

This patent application is claiming the benefit of the U.S. Provisional Application having an application number of 60/464,210, filed Apr. 22, 2003, in the name of Warren Gillette and H. Gordon Minns, and entitled “PERSONAL ELECTRONIC STARTER AND TIMER”.

### BACKGROUND OF THE INVENTION

1. Field of the Invention

This invention relates to training equipment and, more specifically, to an electronic starter and timer which will allow a person training alone to conveniently and accurately time their sprints.

2. Description of the Prior Art

Most athletes, whether professionals or the weekend warrior, have to train in order to prepare themselves for competition. Training may include continuous training, interval training, simulated race training, and the like. Continuous training is when an athlete exercises in a steady aerobic way. Interval training is characterized by repetitions of work with a recovery period following each repetition. Both continuous training and high-intensity interval training is known to boost endurance performance. Simulated race training, as the name implies is a simulated timed race event. Timed events provide an ability to measure improvement and to record performance.

To properly conduct the above training activities, athletes have relied on either a coach or training partner for assistance in properly monitoring training times. When the athlete is left to train alone, the athlete has to attempt to provide timing and race simulation on his own. This is generally done by the athlete using some type of stopwatch to self-time the training run. Self-timing of events is very difficult and often prone to error. Thus, simulating race conditions is nearly impossible when done alone.

There are several timing devices that have been proposed to assist in timing racing events. For example, U.S. Pat. No. 3,596,103 discloses a system for automatically recording race times for several race participants. The device includes a structure for aligning a plurality of photocell/light beam devices with the lanes of the race course. When a participant passes the structure, the circuit breaking element interrupts a timer associated with that lane. The timing devices are simultaneously started as a result of a race participants motion away from the starting blocks. A swimming race timing device is disclosed in U.S. Pat. No. 5,349,569. The device includes a start signal generator, a block signal generator for detecting when the swimmers feet leave the platform and a touch panel for producing a stop signal. The touch panel is specifically designed to be responsive to touches at oblique angles. Both of the above devices have several problems associated with them. First, both devices are relatively expensive. Thus, only serious athletes who belong to a club would probably have the benefit of having one of the above devices. Furthermore, both are burdensome and time consuming to set-up and are not easy to transport. Thus, someone training alone would have a difficult time setting up the above devices.

Therefore, there is a need to provide an improved electronic starter and timer. The improved electronic starter and timer must overcome the problems associated with prior art devices. The improved electronic starter and timer must be relatively inexpensive, easy to use, and easy to set-up and transport.

### SUMMARY OF THE INVENTION

In accordance with one embodiment of the present invention, it is an object of the present invention to provide an improved electronic starter and timer.

It is another object of the present invention to provide an improved electronic starter and timer that overcomes the problems associated with prior art devices.

It is another object of the present invention to provide an improved electronic starter and timer that is relatively inexpensive, easy to use, and easy to set-up and transport.

### BRIEF DESCRIPTION OF THE EMBODIMENTS

In accordance with one embodiment of the present invention a personal electronic starter and timer is disclosed. The personal electronic starter and timer has a finish line unit for generating an end of race signal across a finish line of a race of a predetermined distance. A body unit is coupled to a body of a person. The body unit is used for generating a countdown signal and starting a timing function after a start signal, the timing function terminating when the body unit reads the end of race signal generated by the finish line unit.

In accordance with another embodiment of the present invention, a personal electronic starter and timer is disclosed. The personal electronic starter and timer has a finish line unit for generating an end of race infrared signal across a finish line of a race of a predetermined distance. A body unit is coupled to a body of a person. The body unit is used for generating a countdown signal and starting a timing function after a start signal is sounded, the timing function terminating when the body unit receives the end of race infrared signal generated by the finish line unit, the body unit storing multiple users, multiple race distances and fastest times for each user and each distance.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of the personal electronic starter and timer of the present invention.

### DETAILED DESCRIPTION OF THE PREFERRED EMBODIMENT

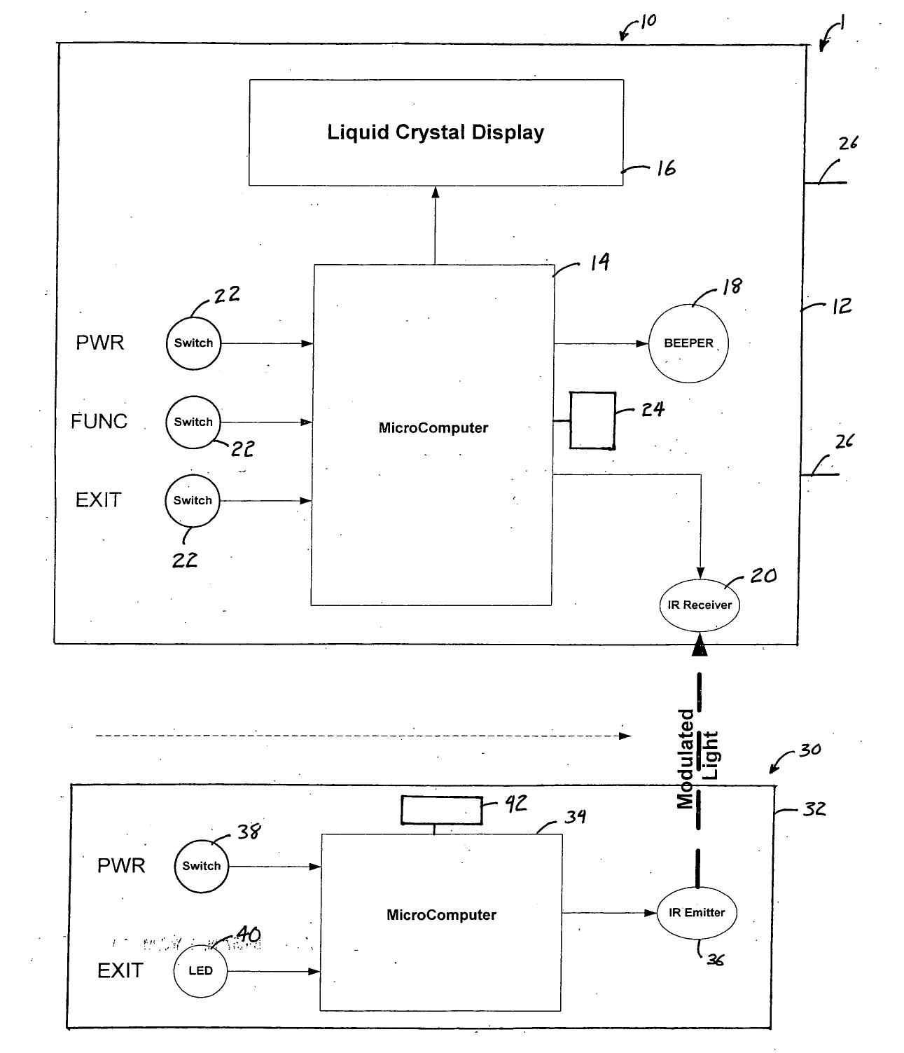

Referring to FIG. 1, a personal electronic starter and timer 1 (hereinafter starter and timer 1) is shown. The starter and timer 1 will allow a person training alone to easily and accurately time their training runs. The starter and timer 1 is comprised of two main components: a body unit 10 and a finish line unit 30.

The body unit 10 has an outer casing 12. The outer casing 12 is used to house the components of the body unit 10. The outer casing 12 is used to protect the components from the environment. The outer casing 12 is generally comprised of a light weight but sturdy material. For example, some type of plastic material may be used or a light weight metal like aluminum may be used. The above are given as an example and should not be seen as to limit the scope of the present invention.

The internal components of the body unit 10 comprises: a microcomputer 14, a display unit 16, a speaker 18, a receiver 20, a plurality of buttons 22, and a power supply 24. The microcomputer 14 is generally a microcontroller which may be programmed to perform a plurality of different functions. The different functions will be described in relation to the other components and the operation of the body unit 10.

The display unit 16 is coupled to the microcomputer 14. The display unit may be a Liquid Crystal Display (LCD), a Light Emitting Diode (LED) display, or the like. The listing of the above should not be seen as to limit the scope of the present invention. The display unit 16 is use to display the different times recorded by the body unit 10.

A speaker circuit 18 is also coupled to the microcomputer 14. The speaker circuit 18 is generally a small speaker unit which is coupled to the microcomputer 14. The speaker circuit 18 is used to provide audible directions to the user. The audible directions are mainly a countdown to when the timed event will begin and a start signal. However, other audible directions may be programmed in the microcomputer 14 and played through the speaker circuit 18. When the countdown is completed, the microcomputer 14 will start a timing function to record the time it takes a person to finish his/her training run.

A receiver unit 20 is also coupled to the microcomputer 14. The receiver unit 20 is used to receive an end of race signal generated from the finish line unit 30. The receiver unit 20 may be implemented with several technologies. For example, the receiver unit 20 may be able to detect a light signal. Alternatively, the receiver unit 20 may be able to detect radio frequency energy (RF). The receiver unit 20 may also be one which can detect an audio signal, including ultrasonic audio energy. In the embodiment depicted in the Figure, the receiver unit 20 is an infrared receiver unit. The receiver unit 20 is designed to filter out and ignore other signals which may cause a false reading. For example, if the receiver unit 20 is used to detect a light signal, the receiver unit 20 can be set so that only those light signals which fall in a particular hertz range is detected. Furthermore, the receiver unit 20 is mounted in the body unit 10 to protected the receiver 20 from the elements. For example, if the receiver unit 20 is used to receive light signals, the receiver unit 20 needs to be angled below the horizon and shielded from direct sunlight. Once the receiver unit 20 detects the end of race signal at the finish line, the receiver unit 20 will transmit a signal to the microcomputer 14 which will stop the timing function. The time recorded by the microcomputer 14 will then be displayed on the display unit 16.

The body unit 10 will have a plurality of buttons 22 coupled to the microcomputer 14. The buttons 22 will be placed on the outer surface of the outer casing 12. The buttons 22 will be used by the person training to control the operation of the microcomputer 14. The function of the buttons 22 will be described further in the Operation section.

A power supply 24 is coupled to the microcomputer 14. The power supply 24 is used to power the different components of the body unit 10. The power supply 24 may power the different components via the microcomputer 14 or alternatively, the power supply 24 may be individually coupled to the different components in the body unit 10. The power supply 24 is generally a DC power supply like a low voltage battery.

The finish line unit 30 has an outer casing 32. The outer casing 32 is used to house the components of the finish line unit 30. The outer casing 32 is used to protect the components from the environment. The outer casing 32 is generally comprised of a light weight but sturdy material. For example, some type of plastic material may be used or a light weight metal like aluminum may be used. The above are given as an example and should not be seen as to limit the scope of the present invention.

The finish line unit 30 is comprised of a microcomputer 34, an emitter 36, at least one switch 38, a signal light 40, and a power supply 42. The microcomputer 34 is generally a microcontroller which may be programmed to perform a plurality of different functions. The different functions will be described in relation to the other components and the operation of the finish line unit 30.

An emitter 36 is coupled to the microcomputer 34. The emitter 36 is used to send an end of race signal which is detected by the receiver unit 20 at the end of the training run. The end of race signal generated by the emitter unit 36 can be a light signal, a radio frequency (RF) energy signal, or an ultrasonic audio energy signal. In the embodiment depicted in the Figure, the emitter 36 sends out an infrared signal.

A switch 38 is coupled to the microcomputer 34. The switch 38 is located on the exterior surface of the outer casing 32. The switch 38 is used to activate and deactivate the finish line unit 30. By moving the switch 38 to the “ON” position, the finish line unit 30 will transmit the end of race signal across the finish line of the training run.

A light signal 40 is coupled to the microcomputer 34. The light signal 40 is located on the exterior surface of the outer casing 32. The light signal 40 is an indicator light to signal when the finish line unit 30 is active. The light signal 40 may be an LED, or other type of light source. The listing of the above should not be seen as to limit the scope of the present invention.

A power supply 42 is coupled to the microcomputer 34. The power supply 42 is used to power the different components of the finish line unit 30. The power supply 42 may power the different components via the microcomputer 34 or alternatively, the power supply 42 may be individually coupled to the different components in the finish line unit 30. The power supply 42 is generally a DC power supply like a low voltage battery.

Referring to the embodiment in the Figure, in operation, the body unit 10 will have three control buttons 22: POWER, FUNCTION, and EXIT. In order to activate the body unit 10, one presses the SELECT button. When first turned on, the timer enters the finish line Signal Verify Mode. An indicator signal on the display 16 will be steady-on if no signal is detected. When a finish line signal from the Finish Line Unit 30 is detected, the body unit 10 beeps, and the small indicator signal blinks on the display 16. This mode automatically terminates after a few seconds.

The microcomputer 14 is programed to have a plurality of different USERS, race distances, and current units of speed. After the body unit 10 finishes the Signal Verification Mode, and a signal is detected, the display 16 will show a main screen page. The main screen page will indicate the current USER (1-4), the current distance (one of 11), and the current units for speed display (either Miles/Hour or Meters/Second). To start a new race with the currently-displayed settings, press the SELECT button.

The battery 24 is checked before each race. If the battery 24 is getting low, a LoBAT message appears on the display 16. Even with a low battery, the timer will continue to function for at least 1-2 hours.

The time display shows --:-- and READY is shown on the display 16 to indicate that an 8-second “Ready” count-down has begun. Longer or shorter countdowns may be programmed into the microcomputer 14. A single beep every second via the speaker 18 to indicate that the ready count-down is in progress. At the end of the “Ready” period, three short beeps indicate “Get Set.” Then, after a random delay time of 1.5 to 3.0 seconds, the speaker 18 loudly beeps once, and a large STAR appears on the display 16 indicating that timing has begun.

A race in progress can be discontinued by pressing and holding the EXIT button until the screen changes to the default display mode.

When the runner passes the finish line unit 30, the receiver 20 will detect the end of race signal generated by the emitter 36. The timing is terminated, and the time is displayed. Maximum time is 99.00 seconds. If there is a new best time for the current distance setting, a large STAR appears on the display 16, and the body unit 10 beeps several times. There is one best time stored for each of the different users and the different sprint distances.

After viewing the race time, one may press the SELECT button to view the speed in Miles/Hour or Meters/Second. When finished viewing the speed, there are three button choices: SELECT returns to the main display, FUNCTION enters the Configuration/Review Mode, and EXIT turns off the body unit 10.

The Configuration/Review Mode can be entered by pressing FUNCTION button, either from the main screen or after a race. Several functions can be accessed in this order while in this mode: Change User #, Change Distance, Review Best Time, Clear Best Time (for the current user), Change speed units (Miles/Hour or Meters/Second). A “dot” next to the parameter indicates that this is the active parameter that will be changed if the SELECT button is pressed. Each press of the FUNCTION button advances the dot to the next item. To change the current parameter setting (the one with the DOT) press the SELECT button once to activate the ability to change the setting. If you change your mind, pressing FUNCTION will move on to the next parameter. To actually change the parameter setting, press the SELECT button again. Each subsequent pressing of the SELECT button will display all of the choices, and then wrap around to the first choice. When clearing best times, pushing SELECT will first give you a choice of NO or YES, to make sure that indeed you intend to clear the time. To keep a new setting, press the FUNCTION button, which saves the choice and moves on to the next choice. When finished with viewing or changing settings, press the EXIT button to return to the main-screen.

In general, one may restore the default settings if there seems to be a problem with the body unit. To do so, turn off the body unit 10 and hold down both the FUNCTION and EXIT buttons. While holding these 2 buttons down, press the SELECT button and keep holding all three buttons down for at least 2 seconds. After all three buttons are released, the body unit 10 will beep 4 times, to indicate that restoration of default settings are in progress. The process takes several seconds to complete, and then the main screen will appear with the default settings of 10 meters and user # 1 displayed. The default speed units are Meters/Second.

The body unit 10 is attached to the side of the sprinter by straps 26. The straps 26 are generally made of a hook and loop material so that the straps may be adjusted. The long axis of the body unit 10 should be parallel to the ground with the receiver 20 facing down, so it interacts with the finish line unit 30 at the finish line.

The finish line unit 30 needs to be turned on so that the end of race signal is sent out. To turn on the end of race signal, one presses the PWR button. The light signal 40 indicates that the finish line unit 30 is ON, and is emitting the coded finish line signal. To turn off the finish line unit 30, press the PWR button again. The finish line unit 30 will automatically turn off after a predetermined time frame in order to conserve power. Thus, one must be sure to turn it off, then on again to reset the auto-off timer before each race. Otherwise, the finish line unit 30 may be off when the athlete crosses the finish line and the timer will not stop.

If the power supply needs to be replaced, the light signal 40 blinks for a few seconds when the finish line unit 30 is turned on. The finish line unit 30 will still operate for at least an additional hour, but with reduced end of race signal output.

The finish line unit 30 is positioned at the finish line. The finish line unit 30 is positioned so that the emitter 36 and thus the end of race signal is pointed across the finish line. The finish line unit 30 should be RESET after each race.

The sprinter should pass by the finish line unit 30 at a distance of about one yard so the finish line unit beam turns off the clock on the body unit 10. To test if they interact at the finish line, set the distance to be run at zero, and run through the finish line from a short distance out. Run about one yard to the side of the finish line unit 30. The body unit 10 and the finish line unit 30 should interact at this distance. If not, adjust the distance that you pass by the finish line unit 30, until the two units 10 and 30 interact. A taller runner may have to run further from the side of the finish line unit 30 than a shorter runner in order for the finish line unit to communicate with the body unit 10.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A personal electronic starter and timer comprising:
a finish line unit for generating an end of race signal across a finish line of a race of a predetermined distance; and
a body unit coupled to a body of a person for generating a countdown signal and starting a timing function after a start signal, the timing function terminating when the body unit reads the end of race signal generated by the finish line unit.

2. A personal electronic starter and timer in accordance with claim 1 wherein the finish line unit comprises:
a microcontroller unit;
an emitter coupled to the microcontroller for sending out the end of race signal; and
a power supply coupled to the microcontroller.

3. A personal electronic starter and timer in accordance with claim 2 wherein the finish line unit further comprises an indicator signal coupled to the microcontroller for showing when the finish line unit is activated.

4. A personal electronic starter and timer in accordance with claim 2 wherein the finish line unit further comprises a switch coupled to the microcontroller for activating and deactivating the finish line unit.

5. A personal electronic starter and timer in accordance with claim 2 wherein the finish line unit further comprises a housing to protect internal components of the finish line unit.

6. A personal electronic starter and timer in accordance with claim 1 wherein the body unit stores multiple users, multiple race distances and fastest times for each user.

7. A personal electronic starter and timer in accordance with claim 1 wherein the body unit comprises:
a microcontroller;
a display unit coupled to the microcontroller;
a receiver device coupled to the microcontroller for receiving the end of race signal; and
a power supply coupled to the microcontroller.

8. A personal electronic starter and timer in accordance with claim 7 wherein the body unit further comprises a speaker coupled to the microcontroller to provide audible signals.

9. A personal electronic starter and timer in accordance with claim 7 wherein the body unit further comprises a plurality of buttons to activate and deactivate the body unit and to scroll through menu features of the body unit.

10. A personal electronic starter and timer in accordance with claim 7 wherein the body unit further comprises a housing to protect internal components of the body unit.

11. A personal electronic starter and timer in accordance with claim 1 wherein the end of race signal is an infrared signal.

12. A personal electronic starter and timer comprising:
a finish line unit for generating an end of race infrared signal across a finish line of a race of a predetermined distance; and
a body unit coupled to a body of a person for generating a countdown signal and starting a timing function after a start signal is sounded, the timing function terminating when the body unit receives the end of race infrared signal generated by the finish line unit, the body unit storing multiple users, multiple race distances and fastest times for each user and each distance.

13. A personal electronic starter and timer in accordance with claim 11 wherein the finish line unit comprises:
a first microcontroller unit;
an emitter coupled to the first microcontroller for sending out the end of race signal;
an indicator signal coupled to the first microcontroller for showing when the finish line unit is activated; and
a power supply coupled to the first microcontroller.

14. A personal electronic starter and timer in accordance with claim 13 wherein the finish line unit further comprises a switch coupled to the microcontroller for activating and deactivating the finish line unit.

15. A personal electronic starter and timer in accordance with claim 13 wherein the finish line unit further comprises a housing to protect internal components of the finish line unit.

16. A personal electronic starter and timer in accordance with claim 12 wherein the body unit comprises:
a second microcontroller;
a display unit coupled to the second microcontroller;
a receiver device coupled to the second microcontroller for receiving the end of race signal; and
a power supply coupled to the second microcontroller.

17. A personal electronic starter and timer in accordance with claim 16 wherein the body unit further comprises a speaker coupled to the second microcontroller to provide audible signals.

18. A personal electronic starter and timer in accordance with claim 16 wherein the body unit further comprises a plurality of buttons coupled to the second microcontroller to activate and deactivate the body unit and to scroll through menu features of the body unit.
